(19) United States
(12) Patent Application Publication
(10) Pub. No.: US 2010/0158621 A1
(43) Pub. Date: Jun. 24, 2010

(54) CUTTING TOOL FOR RECESSING AND GROOVING, COMPRISING A REPLACEABLE ABUTMENT FOR THE CUTTING ELEMENT

(76) Inventors: Wolfgang Zitzlaff, Deutschland (DE); Marian Zintz, Deutschland (DE)

Correspondence Address: FULBRIGHT & JAWORSKI, LLP, 666 FIFTH AVE, NEW YORK, NY, 10103-3198, US

(21) Appl. No.: 12/595,004

(22) PCT Filed: Apr. 14, 2008
(86) PCT No.: PCT/EP08/54460

§ 371 Date: Oct. 7, 2009

(30) Foreign Application Priority Data
Apr. 20, 2007 (DE) 10 2007 019 135.0

(51) Int. Cl. B23B 29/04; B23P 15/28

(52) U.S. Cl. 407/102

(57) ABSTRACT

The invention relates to a cutting tool (1) for machining mainly metallic materials, comprising a clamping holder (2) and support (3) for the cutting element. Said support (3), on which a cutting element (6) rests, is arranged on the clamping holder (2). The cutting element (6) is pressed, by means of a clamping claw (5), onto the support (3) for the cutting element and against an abutting surface (7) located outside the support (3) for the cutting element. In order to increase the service life of the clamping holder, the abutting surface (7) is part of an abutment (4) for the cutting element. Said abutment (4) is designed as a separate component and is replaceably mounted on the clamping holder (2).

The invention relates to a cutting tool for machining mainly metallic materials, having a gripping holder and a cutting-body support which is arranged on the gripping holder and on which there rests a cutting body that is pressed by a clamping claw onto the cutting-body support and onto an abutment surface that is arranged outside the cutting-body support.

Today, a plurality of grooving systems and cutting tools with replaceable cutting bodies, cutting-body supports and devices for holding down cutting bodies or clamping claws and other types of cutting-body securement pertain to the prior art in the machining industry. Many cutting tools are limited in this connection to recessing, mostly the cutting of grooves, in which the cutting tool is moved only in the axial direction. The cutting pressure that develops as a result of the cutting forces during the metal-removing grooving process and the chips that occur on the cutting body give rise to heat-development and wear at the cutting body and the components surrounding it. The cutting-pressure-absorbing abutment surface for the cutting body is mostly a planar or prism-like surface on the base carrier itself. This abutment surface that is provided directly on the base carrier or even on the cutting-body support is liable to have only a limited service life on account of the continuous cutting pressure and thermal loading and must be replaced regularly in order to guarantee a reliable machining process and work pieces that are dimensionally correct.

If now in the case of application for the usual axial movement a radial movement of the cutting tool is further added—this is the case, for example, with thread-cutting or profile—and contour-turning—the cutting forces that occur additionally also act laterally on the whole grooving and clamping system.

As a result of the mostly unfavourable width to length ratio of the cutting bodies, as a result a lever motion develops on the cutting body which tend to move it out of its fixed position. This movement often results in the failure of the whole clamping system. Process-reliability is thus put at risk; breakage of the cutting body with unforeseen damage to people and material can be the consequence.

The underlying object of the invention is to improve a cutting tool according to the preamble of claim 1 in such a way that as a result of exchanging components that are susceptible to wear it has a longer useful life.

This object is achieved in that the abutment surface is part of a cutting-body abutment that is formed as a separate component and is secured to the gripping holder in an exchangeable manner. By exchanging the cutting-body abutment in the event of wear, the gripping holder is ready for further use and does not need to be replaced.

In an inventive configuration, the cutting-body abutment can be secured on the gripping holder in at least two directions of installation, with one abutment surface being available for the cutting body in each direction of installation. The complete exchange of a cutting-body abutment is as a result only necessary when all the abutment surfaces of the cutting-body abutment are worn.

In a development of the invention, the cutting-body abutment has two end faces, with one abutment surface being arranged on each end face and as a result of turning the cutting-body abutment on the gripping holder a respective abutment surface being available for the cutting body. The cutting-body abutment is preferably formed in a parallelepiped shape.

The cutting-body abutment is preferably secured to the gripping holder by means of screws.

In an inventive configuration, the cutting-body abutment can be positioned on the gripping holder in an accurate manner in terms of fit by way of a tongue-and-groove connection. As a result, in the event of exchange and also in the case of use the cutting-body abutment cannot slip on the gripping holder.

In a development of the invention, the cutting-body abutment rests on a stop face of the gripping holder, and two threaded bores for screwing the cutting-body abutment on the gripping holder are introduced in the stop face, and the tongue-and-groove connection is arranged between the threaded bores.

The cutting-body abutment preferably consists of the following or a combination of the following materials: high-alloy and heat-treated steel, hot-work steel or ceramic material.

In a configuration of the invention, elements with particular properties for heat-conduction, damping, or electrical or thermal insulation are arranged between the cutting-body abutment and the gripping holder. These can be elements with low thermal conductivity, for example.

In an inventive development, the cutting-body support, the cutting-body abutment and the clamping claw are guided on the gripping holder with a tongue-and-groove connection in an accurate manner in terms of fit. As a result, these parts are always in the necessary position.

The cutting-body abutment is preferably arranged in the same axial direction as the cutting-body support, whereby both portions are aligned in an optimum manner with respect to the cutting plate.

In an inventive configuration, the cutting body and the cutting-body abutment are guided on the cutting-body support, with the cutting-body support having a guide strip on its side facing the cutting body and the cutting-body abutment, and the cutting body and the cutting-body abutment having a respective engagement element that is matched to the guide strip on their side facing the cutting-body support, or vice versa. This renders possible optimum alignment of these portions.

Expediently, the guide strip is a channel-like depression, and the engagement elements are spherical projections.

In an inventive configuration, the gripping holder has a groove, and the cutting-body support has a tongue on its side facing the gripping holder, with the cutting-body support being guided by way of the tongue, which engages into the groove, on the gripping holder in an accurate manner in terms of fit.

Threaded bores are preferably introduced in the groove, and the cutting-body support has through-bores matched to the number of the threaded bores, and screws, projecting through the cutting-body support, are turned into the threaded bores in order to secure the cutting-body support on the gripping holder. As a result, a simple and fixed connection is established.

The cutting-body support and the cutting-body abutment are preferably guided on the same side of the gripping holder.

In an inventive configuration, an oblique plane that is formed as a groove and is inclined towards the rear, that is, away from the cutting body, is arranged on the gripping holder, and the clamping claw rests with a similarly oblique plane that is formed as a tongue on the latter in the manner of a tongue-and-groove connection. As a result, on the one hand the clamping claw is guided and on the other hand it experiences a drawing movement away from the cutting body when secured to the gripping holder.

The oblique plane that is formed as a tongue is preferably formed by individual points of support.

The oblique plane that is formed as a groove is delimited laterally on the one hand by a guide surface on the gripping holder and on the other hand by the cutting-body abutment.

Introduced in the oblique plane that is formed as a groove there is a securing bore that extends at an angle y to the oblique plane and into which a screw projecting through the clamping claw engages in order to secure the claw on the gripping holder.

The angle y preferably lies between 75° and 85° and by preference amounts to 80°.

The oblique plane in one configuration is inclined at an angle z surface of the gripping holder, and the angle z is smaller than 30° and greater than 1° and is particularly preferably smaller than 10° and advantageously amounts to 3°.

A cutting-body abutment in accordance with the invention for a gripping holder of a cutting tool for machining mainly metallic materials has in accordance with the invention at least two abutment surfaces for a cutting body, a groove or a fitting piece for the tongue-and-groove connection of the cutting-body abutment with the gripping holder and is provided with two through-bores to fasten the cutting-body abutment with screws to the gripping holder.

Further features of the invention are shown in the figures which are described in the following.

The invention relates to a cutting tool 1 (see figures) which in its basic design can be used in like manner for recessing, thread-cutting and grooving. It always consists of a base carrier, called a gripping holder 2 in the following, of a replaceable cutting-body support 3, a novel replaceable cutting-body abutment 4 and a replaceable device for holding down the cutting body, called a clamping claw 5 in the following. The cutting-body support 3, the cutting-body abutment 4 and the clamping claw 5 form the so-called clamping system and are matched or can be matched in accordance with the invention to the form and function of the cutting body 6 used. The advantage of this invention lies in the use of a replaceable cutting-body abutment 4 and the multifunctional construction of all the components that are used in order to deal with the changing cases of use during machining and to guarantee the user selection and assembly of the components that are as simple as possible. Standardization and modular systematics are to the fore here.

The cutting-body abutment 4 that is used and is exchangeable is to be mentioned here as a particular inventive feature. It has one or more ends matched to the abutting cutting body 6, called abutment surfaces 7 in the following, and is predominantly secured by means of screws 8 on the contact surface 9 of the gripping holder 2. This cutting-body abutment 4 is arranged in the same axial direction as the cutting-body support 3. The gripping holder 2 (see FIG. 4) has in the same axial direction a groove or guide groove 10 and securing bores or threaded bores 11. At right angles to the guide groove 10 in the centre between the two threaded bores 11 of the cutting-body support 3 there is a groove or guide groove 12 and on both sides thereof there are the associated securing bores or threaded bores 13 for the replaceable cutting-body abutment 4.

The abutment surfaces 7 of the cutting-body abutment 4 have a prismatic form for the form-locking connection between the cutting body 6 and the cutting-body abutment 4 (see for example FIG. 3). As a result, the transverse forces that occur during grooving are absorbed and as a result of the vertical rigidity of the connection the cutting body 6 is prevented from twisting and tilting away. In addition, the cutting body 6 is guided by a further prismatic connection, also referred to as a guide strip 14, between the underside of the cutting body 6 and the upper side of the cutting-body support 3. Possible defects of form and positional errors of the components acting together are compensated for by the same axial alignment of the components and the coordinated tolerances of the abutments, guides and prisms in the technical sense of a clearance fit.

In accordance with the invention, after long-term use and wear of the end that is in use or of the abutment surface 7, by rotation about 180° the cutting-body abutment 4 can be put to further use again with a non-worn end or a non-worn abutment surface 7. The tongue-and-groove connection and a stop face 15 between the base body, that is, the clamping holder 2, and the cutting-body abutment 4 upon rotation of the cutting-body abutment 4 guarantee renewed positioning in an accurate manner in terms of fit. The cutting-body abutment 4 can thus be used several times and presents the user with an inexpensive extension of the service life of the whole grooving system and a high level of process reliability.

The ease of replaceability of the components makes it possible to use a great variety of cutting-body abutments 4 with differently shaped ends or abutment surfaces 7, widths and lengths. What is to be emphasized in particular is that the differently shaped abutment surfaces 7 are matched to the different shapes, widths and lengths of the required cutting bodies 4. In accordance with the invention it is of course also possible to use the same or differently shaped abutment surfaces 7 on a cutting-body abutment 4. The cutting-body abutment 4 can moreover be produced from different materials, for example standard heat-treatable steels in normal applications, super-speed steels or hot-work steels in the case of high loads as a result of high cutting pressures or instances of heat-development that occur in different ways when machining different materials with cutting bodies made from ceramic material, mixed ceramic material, cubic boron nitrite, polycrystalline diamonds or hard metal.

A further inventive feature is the particular embodiment and mounting of the holding-down device. This holding-down device, also known as a clamping claw 5, is mostly secured on the upper side 16 of the base body 2 by means of, for example, a securing screw 17. The clamping claw 5 is guided mostly in a position-determining form, referred to as a guide surface 18 in the following (see FIG. 5). The clamping force of the securing screw 17 exerts a clamping force on the cutting body 6 by way of the contact points 19 (see FIG. 6) between the upper side 16 of the gripping holder 2 that is slanted towards the rear and the clamping claw 5 and the contact zone 20 (in a special embodiment a lug on the clamping claw) between the cutting body 6 and the clamping claw 5. As a result of this clamping force, the cutting body 6 is pressed into the prism or guide strip 14 onto the cutting-body support 3.

The particular embodiment of the mounting (16 and 18) of the clamping claw 5 is established by an oblique plane 16 that is inclined towards the rear on the gripping holder 2. The underside 21 of the clamping claw 5 is formed in a similarly oblique manner and has moreover in the vicinity of the outer edges defined points of support 19 (see FIG. 6). By way of these points of support 19, by means of the incipient clamping force that is exerted by tightening the securing screw 17, also referred to as a clamping screw, a linear movement is exerted away from the cutting body 6 towards the rear, parallel to the position of the components. Lateral guidance in the form of a further tongue-and-groove connection by means of the guide surface 18 and the inside 22 of the cutting-body abutment 4 prevents the clamping claw 5 from twisting during this clamping process. By means of the resultant forces and the force- or form-locking connection between the clamping-claw lug or contact zone 20 and the surface of the cutting body 6, the cutting body 6 is drawn in a form-locking manner onto the one end or onto the abutment surface 7 of the cutting-plate abutment 4. An optimum connection in accordance with the invention of the components surrounding the cutting body 6 results.

The clamping-claw lug or contact zone 20 has moreover in the contact and engagement region with the cutting body 6 a form that is matched to the cutting-body surface. This form is usually determined in terms of width, length and surface by the cutting body 6. Possible forms are smooth and prismatic forms and also troughs and special, round or oval troughs or double troughs. A preferred trough is described in EP 1 536 903 B1 (referred to as a double trough).

In accordance with the invention the width-to-height ratio of the clamping-claw lug amounts to at least 1:2 in order to attain sufficient flexural and torsional rigidity. A further inventive special feature (see FIG. 8) of this clamping system is the axis 23 of the securing bore or threaded bore 24 for the securing screw 17 of the clamping claw 5 that extends slantwise at an angle y. This angle y in accordance with the invention lies between 75° and 85°, with 80° proving to be particularly effective when exerting the force components which act, as intended, towards the rear. In this sectional representation, once again the surface that extends slantwise towards the rear at the angle z or the oblique plane 16 of the gripping holder 2 that forms the supporting surface for the clamping claw 5 can also be seen clearly. Both angles (y and z) perform the functions connected therewith by way of a resultant-force component which in a controlled manner by way of all the acting components firmly fixes the cutting body 6 in the matched recesses (7 and 14). In the right-hand diagram of FIG. 8, the plan view of the gripping holder 2 can be seen again, showing once again the position and form of the groove or guide groove 12. The form together with the form of the cutting-body abutment is a tongue-and-groove connection which, as shown, can be constructed as a dovetail guide or even simply at right angles.

The cutting body 6 is preferably provided with a clamping trough, as described in WO 03/013770 A1. This clamping trough is formed in a circular manner and has in the centre a spherical or circular elevation. The elevation preferably lies above the trough base and below the upper side of the cutting body. For clamping on the gripping holder 2, the clamping claw 5 with a matched shaped lug engages in the trough of the cutting body 6 in a form-locking manner. This trough is used for the form-locking clamping on the gripping holder 2. This cutting body 6 with the special trough is suitable particularly for drawing cuts in which the cutting body could be drawn out of its seat by the acting cutting forces.

EP 1 536 903 B1 describes, as already further described above, a cutting body 6 for clamping in a cutting tool for machining cast materials with a cutting-body upper side, a first clamping trough for clamping in the cutting tool and a cutting edge for metal-removing processing. So that lapping or grinding operations on the cutting-body upper side do not affect the gripping properties of the cutting body, a second clamping trough is arranged coaxially with respect to the first clamping trough, with the first clamping trough being arranged at a deeper level than the second clamping trough and both being deeper than the cutting-body upper side. When gripping this cutting body in a tool, the clamping claw of the tool rests on the second clamping trough and engages, for example, with a lug in the first clamping trough.

As described in WO 2005/021192 A1, the cutting body 6 can be of PCBN or a CBN composite material, with the cutting body having a clamping trough. The clamping trough can be formed in a circular manner and have in the centre a spherical or circular elevation. The corresponding contour of the clamping trough is preferably introduced by correspondingly shaping the green body, and the green body thus produced is then dried and sintered.

The cutting body can also be provided with a coating.

1-22. (canceled)

23. A cutting tool for machining mainly metallic materials, comprising a gripping holder and a cutting-body support which is arranged on the gripping holder and on which there rests a cutting body that is pressed by a clamping claw onto the cutting-body support and onto an abutment surface that is arranged outside the cutting-body support, wherein the abutment surface is part of a cutting-body abutment that is formed as a separate component and is secured to the gripping holder in an exchangeable manner.

24. A cutting tool according to claim 23, wherein the cutting-body abutment can be secured on the gripping holder in at least two directions of installation, and one abutment surface is available for the cutting body in each direction of installation.

25. A cutting tool according to claim 23, wherein the cutting-body abutment has two end faces, one abutment surface is arranged on each end face and as a result of turning the cutting-body abutment on the gripping holder a respective abutment surface is available for the cutting body.

26. A cutting tool according to claim 22, wherein the cutting-body abutment is secured to the gripping holder with screws.

27. A cutting tool according to claim 22, wherein the cutting-body abutment can be positioned on the gripping holder in an accurate manner in terms of fit with a tongue-and-groove connection.

28. A cutting tool according to claim 27, wherein the cutting-body abutment rests on a stop face of the gripping holder, two threaded bores for screwing the cutting-body abutment on the gripping holder are introduced in the stop face, and the tongue-and-groove connection is arranged between the threaded bores.

29. A cutting tool according to claim 22, wherein the cutting-body abutment comprises at least one material selected from the group consisting of high-alloy and heat-treated steel, hot-work steel and ceramic material.

30. A cutting tool according to claim 22, wherein elements having properties for heat-conduction, damping, or electrical or thermal insulation are arranged between the cutting-body abutment and the gripping holder.

31. A cutting tool according to claim 22, wherein the cutting-body support, the cutting-body abutment and the clamping claw are guided on the gripping holder with a tongue-and-groove connection in an accurate manner in terms of fit.

32. A cutting tool according to claim 22, wherein the cutting-body abutment is arranged in the same axial direction as the cutting-body support.

33. A cutting tool according to claim 22, wherein the cutting body and the cutting-body abutment are guided on the cutting-body support, with the cutting-body support having a guide strip on its side facing the cutting body and the cutting-body abutment, and the cutting body and the cutting-body abutment having a respective engagement element that is matched to the guide strip on their side facing the cutting-body support, or vice versa.

34. A cutting tool according to claim 33, wherein the guide strip is a channel-like depression, and the engagement elements are spherical projections.

35. A cutting tool according to claim 22, wherein the gripping holder has a groove, and the cutting-body support has a tongue on its side facing the gripping holder, with the cutting-body support being guided by way of the tongue, which engages into the groove, on the gripping holder in an accurate manner in terms of fit.

36. A cutting tool according to claim 35, wherein threaded bores are introduced in the groove, and the cutting-body support has through-bores matched to the number of the threaded bores, and screws, projecting through the cutting-body support, are turned into the threaded bores in order to secure the cutting-body support on the gripping holder.

37. A cutting tool according to claim 22, wherein the cutting-body support and the cutting-body abutment are guided on the same side of the gripping holder.

38. A cutting tool according to claim 22, wherein an oblique plane that is formed as a groove and is inclined towards the rear, that is, away from the cutting body, is arranged on the gripping holder, and the clamping claw rests with a similarly oblique plane that is formed as a tongue on the latter in the manner of a tongue-and-groove connection.

39. A cutting tool according to claim 38, wherein the oblique plane that is formed as a tongue is formed by individual points of support.

40. A cutting tool according to claim 38, wherein the oblique plane that is formed as a groove is delimited laterally on the one hand by a guide surface on the gripping holder and on the other hand by the cutting-body abutment.

41. A cutting tool according to claim 38, wherein introduced in the oblique plane that is formed as a groove there is a securing bore that extends at an angle y to the oblique plane and into which a screw projecting through the clamping claw engages in order to secure the clamping claw on the gripping holder.

42. A cutting tool according to claim 41, wherein the angle y lies between 75° and 85°.

43. A cutting tool according to claim 22, wherein the oblique plane is inclined at an angle z to the surface of the gripping holder, and the angle z is smaller than 30° and greater than 1°.

44. A cutting tool abutment for a cutting tool according to claim 22, comprising at least two abutment surfaces for a cutting body, a groove or a fitting piece for tongue-and-groove connection of the cutting-body abutment with a gripping holder and having two through-bores to fasten the cutting-body abutment with screws to the gripping holder.
